(19) United States
(12) Patent Application Publication
(10) Pub. No.: US 2008/0147394 A1
(43) Pub. Date: Jun. 19, 2008

(54) SYSTEM AND METHOD FOR IMPROVING AN INTERACTIVE EXPERIENCE WITH A SPEECH-ENABLED SYSTEM THROUGH THE USE OF ARTIFICIALLY GENERATED WHITE NOISE

(75) Inventors: DWAYNE DAMES, BOYNTON BEACH, FL (US); BRENT D. METZ, DELRAY BEACH, FL (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/612,170

(22) Filed: Dec. 18, 2006

(51) Int. Cl. G10L 15/20; G10L 15/00

(52) U.S. Cl. 704/233; 381/94.1; 381/73.1; 704/E21.004

(57) ABSTRACT

A speech processing system for improving a user's experience with a speech-enabled system using artificially generated white noise. The system can include an audible environment that includes at least one microphone and at least one speaker, a white noise generator, a white noise removal engine, and a speech processing system. The white noise generator can be configured to generate white noise to be audibly presented in the audible environment. This white noise can be captured in speech input and the white noise removal engine can digitally preprocess the input to remove the white noise components. The preprocessed input can be processed by the speech processing system and the speech processing system can create speech output based on the received input.

### BACKGROUND

1. Field of the Invention

The present invention relates to the field of speech processing, and, more particularly, to improving an interactive experience with a speech-enabled system through the use of artificially generated white noise.

2. Description of the Related Art

Use of an automated speech-enabled system in a noisy environment is often problematic. A user attempting to listen to automatically generated speech output can have difficulty hearing it or concentrating upon it because of background noise. That is, it is easy for a speech-enabled system user to become distracted by proximate conversations and sounds, which results in a relatively unsatisfying interactive experience with a speech-enabled system.

Environmental solutions, such as walling off an area acoustically may be prohibitively expensive or may be impossible depending upon configuration specifics. For example, acoustically shielding a speech-enabled ATM machine may be cost prohibitive while attempting to screen an environment proximate to a speech-enabled mobile telephone can be impossible due to device mobility.

Another potential solution is to increase the volume of speech output, which has many shortcomings. First, it can increase a noise level of an environment, which can cause proximate individuals to increase their own conversation volume proportionally to the volume increase, which results in the original problem at an increased volume level. Second, simply raising a volume of a speech-enabled system can lead to barge-in detection issues and/or inconsistently effective volume control. Additionally, when dynamic volume adjustments are made, a speech recognition process can be hampered by inconsistent volume levels as an area becomes noisy and quiet.

### SUMMARY OF THE INVENTION

The present invention provides a solution that artificially generates white noise for an acoustic environment in which speech processing occurs, thereby purposefully raising a noise floor of an acoustic environment. The artificially generated white noise can improve a user's experience by drowning out background noise. Components of an input speech signal corresponding to components of the white noise signal can be removed, which results in a clean signal containing only the speech input being processed by a speech processing system. Appreciably, removing input components associated with the generated white noise can ensure that the white noise present in the acoustic environment does not adversely affect speech recognition operations.

The present invention can be implemented in accordance with numerous aspects consistent with material presented herein. For example, one aspect of the present invention can include a speech processing system for improving an interactive experience using artificially generated white noise. The system can include an audible environment that includes at least one microphone and at least one speaker, a white noise generator, a white noise removal engine, and a speech processing system. The white noise generator can be configured to generate white noise to be audibly presented in the audible environment. This white noise can be captured in speech input and the white noise removal engine can digitally preprocess the input to remove the white noise components. The preprocessed input can be processed by the speech processing system and the speech processing system can create speech output based on the received input.

Another aspect of the present invention can include a method for using artificially generated white noise to raise a noise floor of an acoustic environment associated with a speech processing system. Artificially generated white noise can be presented in the acoustic environment at a configurable volume level to establish a noise floor. The system can receive audible speech input from the acoustic environment. This input can be digitally processed to remove the artificially generated white noise. The speech processing system can receive the processed input and can generate artificially generated speech output based upon the received input. The artificially generated speech output can be audibly presented in the acoustic environment.

Still another aspect of the present invention can include a method for improving a user's experience with a speech processing system using artificially generated white noise. The method can begin with white noise being produced into an acoustic environment at an established volume level. Automatically generated speech output can be audibly presented in the acoustic output. Speech input can be captured from the acoustic environment. The white noise can be removed from the captured input, producing clean speech input. The clean speech input can be converted to text.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

It should also be noted that the methods detailed herein can also be methods performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system that artificially generates white noise to improve a user's experience with a speech-enabled automated system in accordance with an embodiment of the inventive arrangements disclosed herein.

FIG. 2 is a flow chart of a method for establishing a noise floor for a speech processing environment using artificially generated white noise in accordance with an embodiment of the inventive arrangements disclosed herein.

FIG. 3 is a flow chart of a method where a service agent can configure a speech processing system to generate white noise in accordance with an embodiment of the inventive arrangements disclosed herein.

### DETAILED DESCRIPTION OF THE INVENTION

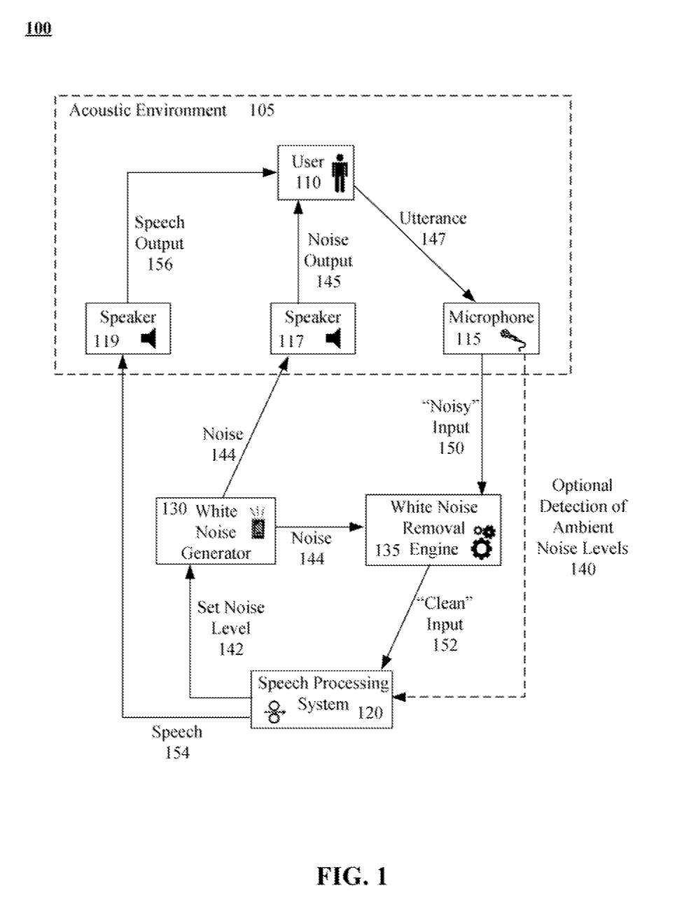

FIG. 1 is a schematic diagram of a system 100 that artificially generates white nose to improve a user's experience with a speech-enabled automated system in accordance with an embodiment of the inventive arrangements disclosed herein. In system 100, a user 110 can attempt to use a speech processing system 120 in an acoustic environment 105 containing some amount of ambient noise. For example, the user 110 can be using a voice-enabled mobile phone inside an automobile with the radio playing.

The acoustic environment 105 can contain the user 110, a microphone 115, and speakers 117 and 119. The microphone 115 can optionally detect the ambient noise levels 140 of the acoustic environment 105 and convey these levels to the speech processing system 120. Receipt of this information can cause the speech processing system 120 to set the noise level 142 of the white noise generator 130.

In an alternate embodiment, the speech processing system 120 can be unable to configure the noise level of the white noise generator 130; the generated white noise can be set to a fixed level and maintained independently of the speech processing system. For example, the white noise generator 130 could be a sound system playing background music in a store, where the store personnel would control the music volume and not the speech processing system of a customer's mobile phone. In another example, the white noise generator 130 can produce a relatively consistent sound at an approximately constant volume.

The white noise generator 130 can then generate a noise signal 144 and transmit the noise 144 to a speaker 117 that produces noise output 145. A user 110 can provide an utterance 147 which can be captured by the microphone 115 as “noisy” input 150. It should be noted that the “noisy” input 150 captured by the microphone 115 contains the utterance 147 spoken by the user 110 as well as noise output 145.

The microphone 115 can pass the captured “noisy” input 150 to a white noise removal engine 135. The white noise removal engine 135 can be a mechanism for removing white noise from a received input signal. Additionally, the white noise removal engine 135 can receive the noise 144 generated by the white noise generator 130. The white noise removal engine 135 can remove the noise 144 components from the “noisy” input 150 to produce a “clean” input 152 signal that is sent to the speech processing system 120.

Upon receipt of the “clean” input 152, the speech processing system 120 can perform a set of programmatic actions associated with the input. Such processing can produce a speech 154 signal that can be conveyed to the user 110 as speech output 156 via speaker 119.

It should be appreciated that the various components of system 100 can occur in a variety of configurations. In one such configuration, items 115, 117, 119, 120 130, and 135 can be integrated into a single device, such as a speech-enabled multimedia computer. In an alternate configuration, the speech processing system 120 can be a network element, such as a Web portal application, while items 115, 117, 119, 130, and 135 can reside on a client device, such as a personal computer. Further, a single speaker 117 can be used to convey both the noise output 145 and the speech output 156 instead of separate elements. In still another configuration, the white noise generator 130 and/or the white noise removal engine 135 can be an integrated component of the speech processing system 120.

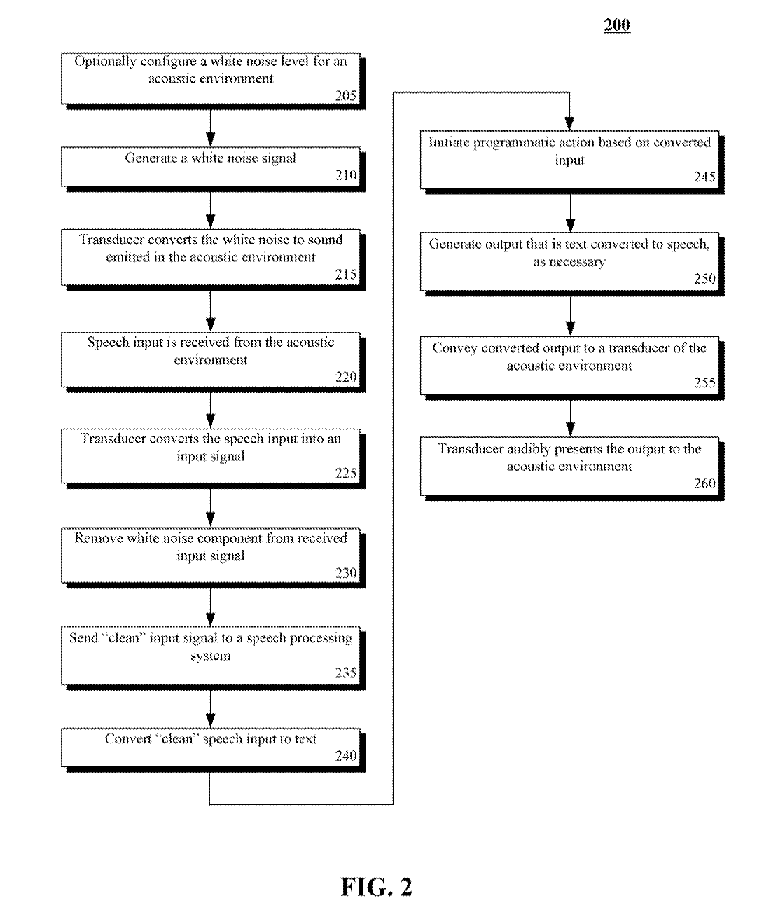

FIG. 2 is a flow chart of a method 200 for establishing a noise floor for a speech processing environment using artificially generated white noise in accordance with an embodiment of the inventive arrangements disclosed herein. Method 200 can be performed in the context of a system 100.

Method 200 can begin in step 205, where a white noise level can be optionally configured for an acoustic environment. In step 210, a white noise signal can be generated. A transducer can convert the white noise signal to sound emitted in the acoustic environment in step 215. In step 220, speech input, assumed to contain a command for a speech-enabled system, can be received from the acoustic environment.

The speech input can be converted to an input signal by a transducer in step 225. In step 230, the white noise component of the received input signal can be removed, resulting in a “clean” input signal. Removal of the white noise component can require the performance of one or more digital signal processing (DSP) actions. For example, a waveform associated with a white noise signal can be subtracted from the “noisy” speech input. Additionally, one or more transformations can be performed to account for audible changes between white noise contributions received by the microphone and a “pure” white noise signal that was generated by the white noise generator. In step 235, the “clean” input signal can be sent to a speech processing system. In step 240, the “clean” speech input can be converted to text.

Based on the converted input, step 245 can initiate a programmatic action. The system can then generate output, converting text to speech, as necessary, in step 250. In step 255, the converted speech output can be conveyed into the acoustic environment by a transducer. The transducer can audibly present the speech output in the acoustic environment in step 260.

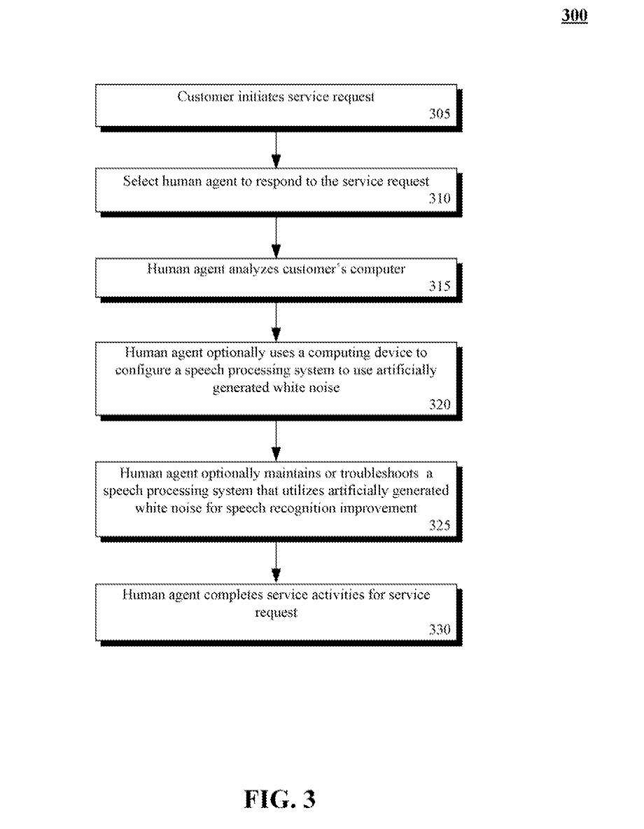

FIG. 3 is a flow chart of a method 300 where a service agent can configure a speech processing system to generate white noise in accordance with an embodiment of the inventive arrangements disclosed herein. Method 300 can be performed in the context of system 100 and/or method 200.

Method 300 can begin in step 305, when a customer initiates a service request. The service request can be a request for a service agent to provide a customer with a new speech processing system using artificially generated white noise. The service request can also be for an agent to enhance an existing speech processing system with artificially generated white noise. The service request can also be for a technician to troubleshoot a problem with an existing system.

In step 310, a human agent can be selected to respond to the service request. In step 315, the human agent can analyze a customer's current system and/or problem and can responsively develop a solution. In step 320, the human agent can use one or more computing devices to configure a speech processing system to use artificially generated white noise to improve a user's experience with an automated speech-enabled system. This step can include the installation and configuration of a white noise generator and white noise removal engine.

In step 325, the human agent can optionally maintain or troubleshoot a speech processing system that uses artificially generated white noise. In step 330, the human agent can complete the service activities.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A speech processing system comprising:
an audible environment including at least one microphone for receiving speech input and at least one speaker for audibly presenting speech output;
a white noise generator configured to generate white noise that is audibly presented in the audible environment;
a white noise removal engine configured to digitally preprocess speech input captured by the microphone and to remove the white noise components included in the captured input; and
a speech processing system for processing the speech input after being preprocessed by the white noise removal engine and for creating the speech output.

2. The speech processing system of claim 1, wherein the white noise removal engine receives input of a signal generated by the white noise generator, wherein the received signal is subtracted from the speech input to remove the white noise components.

3. The speech processing system of claim 2, wherein the white noise removal engine is configured to perform at least one transformation to account for audible changes between white noise contributions received by the microphone and the white noise of the received signal.

4. The speech processing system of claim 1, wherein the volume level of the white noise presented in the audible environment is configurable.

5. The speech processing system of claim 4, wherein the white noise is audibly presented at an approximately constant volume.

6. The speech processing system of claim 5, wherein the configurable volume level of the white noise establishes a volume floor for the speech processing system.

7. The speech processing system of claim 4, wherein the volume level of the white noise is controllable by the speech processing system.

8. The speech processing system of claim 4, wherein a different speaker is used to audibly present the speech output than a speaker that is used to audibly present the white noise, and wherein a volume level of the speech output is programmatically linked to the volume level of the white noise.

9. The speech processing system of claim 1, wherein the white noise generator, the white noise removal engine, and the speech processing system reside within a same computer device, wherein the speaker and the microphone are communicatively linked to the computing device.

10. A method for using artificially generated white noise to raise a noise floor of a speech processing system comprising:
audibly presenting artificially generated noise at a configurable volume level to establish a noise floor for an acoustic environment;
receiving audible input containing speech obtained from the acoustic environment;
digitally processing the input containing speech to remove the artificially generated noise from the input; and
audibly presenting output containing artificially generated speech to the acoustic environment, wherein the artificially generated speech is generated by a speech processing system, and wherein the speech processing system receives the processed input.

11. The method of claim 10, wherein the presented artificially generated noise is presented at an approximately constant volume level.

12. The method of claim 10, further comprising:
sampling input from the acoustic environment to determine an ambient noise level;
automatically calculating a desired noise floor based upon results of the sampling step; and
automatically adjusting the configurable volume level to achieve the desired noise floor.

13. The method of claim 10, further comprising:
a noise removal engine receiving a signal from a noise generator, which generates the artificially generated noise, said signal including a waveform of the artificially generated noise; and
digitally subtracting the waveform of the artificially generated noise from the received audible input.

14. The method of claim 10, wherein said steps of claim 1 are performed by at least one machine in accordance with at least one computer program having a plurality of code sections that are executable by the at least one machine.

15. The method of claim 10, wherein the steps of claim 10 are performed by at least one of a service agent and a computing device manipulated by the service agents, the steps being performed in response to a service request.

16. A method for improving a user's experience with a speech-enabled system using artificially generated white noise comprising:
producing white noise in an acoustic environment at an established volume level;
audibly presenting automatically generated speech output in the acoustic output;
capturing speech input from the acoustic environment;
removing the white noise from the captured input to generate clean speech input; and
speech-to-text converting the clean speech input.

17. The method of claim 16, further comprising:
changing the established volume level at which the white noise is produced; and
automatically adjusting a volume level of the automatically generated speech output in accordance with the changed volume level of the white noise.

18. The method of claim 16, wherein the established volume level is a configurable value and is an approximately constant volume level.

19. The method of claim 16, wherein the speech-to-text converting step is performed by a speech processing system that also generates the speech output, said speech processing system being configured to establish the volume level of the produced white noise.

20. The method of claim 16, wherein said steps of claim 16 are performed by at least one machine in accordance with at least one computer program having a plurality of code sections that are executable by the at least one machine.
